(19) United States
(12) Patent Application Publication
(10) Pub. No.: US 2015/0040073 A1
(43) Pub. Date: Feb. 5, 2015

(54) Zoom, Rotate, and Translate or Pan In A Single Gesture

(71) Applicant: Google Inc., Mountain View, CA (US)

(72) Inventors: Daniel BARCAY, San Francisco, CA (US); David Kornmann, Tucson, AZ (US); Julien Mercay, Belmont, CA (US)

(73) Assignee: Google Inc., Mountain View, CA (US)

(21) Appl. No.: 13/832,908

(22) Filed: Mar. 15, 2013

Related U.S. Application Data
(60) Provisional application No. 61/704,759, filed on Sep. 24, 2012.

(51) Int. Cl. G06F 3/0481; G06F 3/0488

(52) U.S. Cl. CPC G06F 3/04815; G06F 3/0488
USPC 715/850

(57) ABSTRACT

Embodiments relate to navigating through a three dimensional environment on a mobile device using a single gesture. A first user input is received, indicating that two or more objects have touched a view of the mobile device. Two or more target locations on a surface of the three-dimensional environment corresponding to the two or more objects touching the view of the mobile device are determined. A second user input indicating that the two objects have performed a motion while touching the view of the mobile device is received. Camera parameters for the virtual camera, based on the received second user input, are determined. The virtual camera is moved within the three dimensional environment according to the determined camera parameters, such that the two or more target locations remain corresponding to the two or more objects touching the view of the mobile device. Moving the virtual camera may include zooming, rotating, tilting, and panning the virtual camera.

### CROSS-REFERENCE TO RELATED APPLICATIONS

This application claims the benefit of U.S. Provisional Appl. No. 61/704,759, filed Sep. 24, 2012, which is hereby incorporated by reference in its entirety.

### BACKGROUND

1. Field

Embodiments generally relate to navigation in a three dimensional environment.

2. Background

Systems exist for navigating through a three dimensional environment to display three dimensional data. The three dimensional environment includes a virtual camera that defines what three dimensional data to display. The virtual camera has a perspective according to its position and orientation. By changing the perspective of the virtual camera, a user can navigate through the three dimensional environment.

### BRIEF SUMMARY

Embodiments relate to user interface gestures for moving a virtual camera on a mobile device. In an embodiment, a computer-implemented method navigates a virtual camera in a three dimensional environment on a mobile device having a touch screen. A first user input is received, indicating that two or more objects have touched a view of the mobile device. Two or more target locations on a surface of the three-dimensional environment corresponding to the two or more objects touching the view of the mobile device are determined. A second user input indicating that the two objects have performed a motion while touching the view of the mobile device is received. Camera parameters for the virtual camera, based on the received second user input, are determined. The virtual camera is moved within the three dimensional environment according to the determined camera parameters, such that the two or more target locations remain corresponding to the two or more objects touching the view of the mobile device.

Further embodiments, features, and advantages of the invention, as well as the structure and operation of the various embodiments of the invention are described in detail below with reference to accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram illustrating a mobile device that navigates through a three dimensional environment.

FIG. 2 is a diagram illustrating a virtual camera navigating through a three dimensional environment.

FIG. 3 is a diagram illustrating a system that accepts user interface gestures to navigate through a three dimensional environment.

FIGS. 4A-B are diagrams illustrating determining a target location according to a position selected on a view.

FIG. 5 is a flowchart illustrating a method for zooming on a mobile device.

FIGS. 6A-6B are diagrams illustrating zooming in a three dimensional environment on a mobile device.

FIG. 7 is a flowchart illustrating a method for rotating on a mobile device.

FIG. 8 is a diagram illustrating rotating in a three dimensional environment on a mobile device.

FIG. 9 is a diagram illustrating tilting a virtual camera in a three dimensional environment on a mobile device.

FIG. 10 is a flowchart illustrating a method for tilting a virtual camera.

FIG. 11 is a diagram illustrating tilting a virtual camera in a three dimensional environment.

FIG. 12 is a flowchart illustrating a method for panning a virtual camera.

FIGS. 13A-B are diagrams illustrating panning a virtual camera.

FIG. 14 is a flowchart illustrating a method for navigating a virtual camera using a single gesture.

FIGS. 15-18 are diagrams illustrating moving a camera in accordance with an embodiment.

### DETAILED DESCRIPTION

While the present invention is described herein with reference to the illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Mobile devices, such as cell phones, personal digital assistants (PDAs), portable navigation devices, and handheld game consoles, are being made with improved computing capabilities. Many mobile devices can access one or more networks, such as the Internet. Also, some mobile devices accept input from GPS sensors, accelerometers, gyroscopes, and touch screens. Improved computing capabilities make it possible to run a wide variety of software applications on mobile devices. Many handheld mobile devices have a small display, generally less than 5 inches across. The small display may make it difficult for a use to navigate through a three dimensional environment on a mobile device.

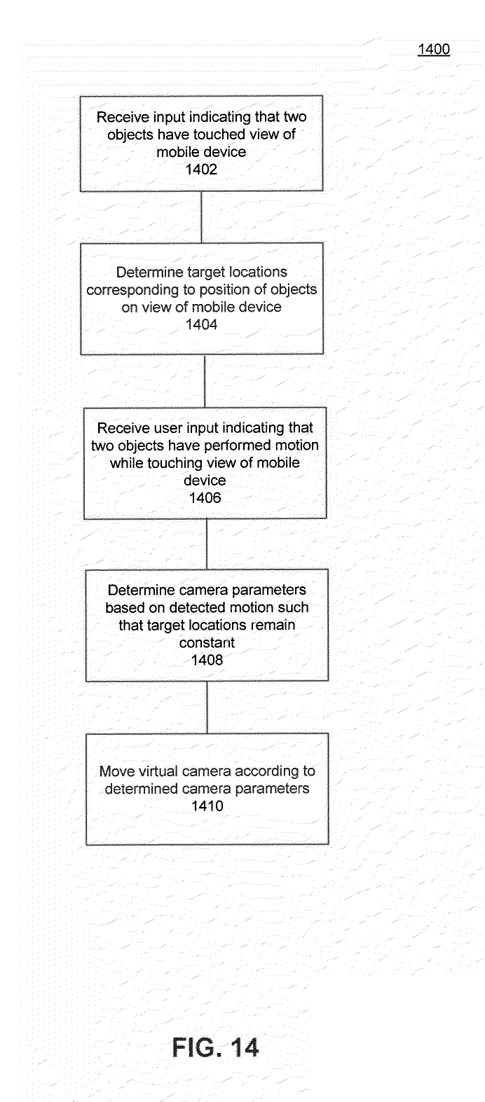

Embodiments disclosed herein relate to zooming, rotating, and translating or panning a virtual camera through a three dimensional environment on a mobile device using a single gesture. First, a system that allows a user to zoom, rotate, and translate or pan a virtual camera. Additionally, gestures for zooming, rotating, translating, and panning a virtual camera in a three dimensional environment are described, in accordance with one embodiment. Finally, navigation through a three dimensional environment using a single gesture, in accordance with an embodiment, is described with reference to the flowchart of FIG. 14. In this way, a user may be able to navigate a virtual camera through a three dimensional environment with a more intuitive, single gesture.

### Introduction

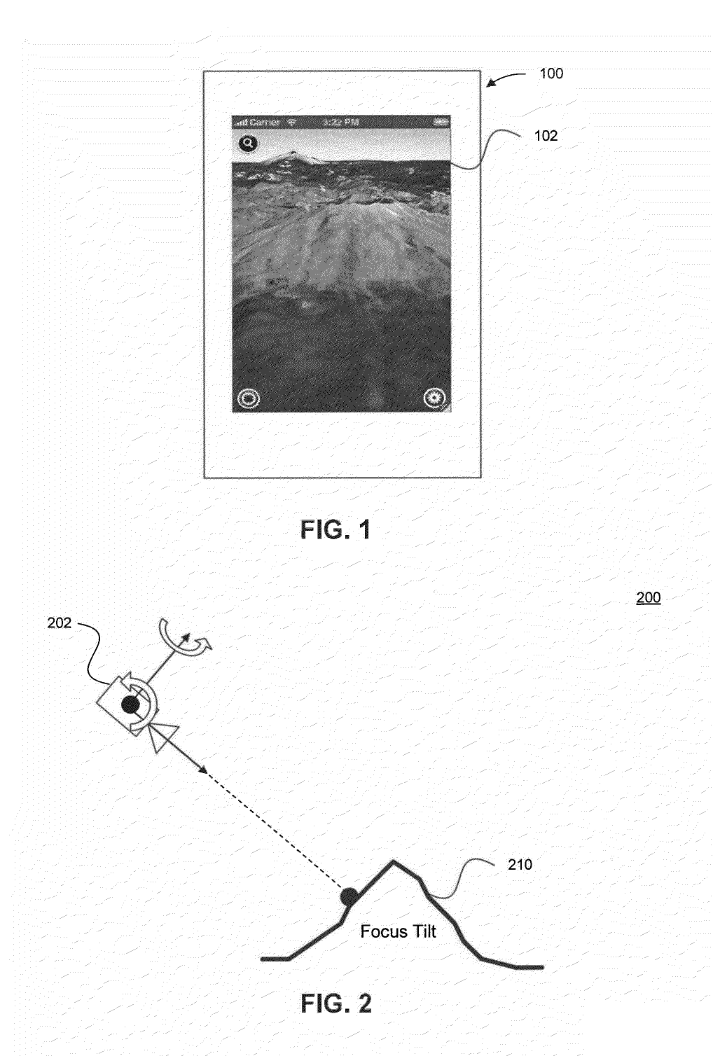

This section provides an overview of navigation in a three dimensional environment on a mobile device. FIG. 1 is a diagram illustrating a mobile device 100 that can navigate through a three dimensional environment. In one embodiment, mobile device 100 may be a smartphone device or mobile telephone. Mobile device 100 may also be a PDA, cell phone, handheld game console or other handheld mobile device as known to those of skill in the art. Mobile device 100 may also be, for example and without limitation, a tablet computer, laptop computer, or other mobile device larger than a handheld mobile device but still easily carried by a user.

Mobile device 100 may have a touch screen that accepts touch input from the user. The user may touch the screen with his fingers, stylus, or other means known to those skilled in the art. Mobile device 100 also may have an accelerometer that detects when the mobile device accelerates or detects mobile device 100's orientation relative to gravity. It should be noted that other devices may be user to determine mobile device 100's orientation, and this invention is not meant to be limited to an accelerometer. One or more accelerometers may be used. Additionally, mobile device 100 may include a gyroscope. Further, mobile device 100 may have a location receiver, such as a GPS receiver, and may be connected to one or more networks such as the Internet.

Mobile device 100 has a view 102. As mentioned earlier, mobile device 100 may accept touch input when a user touches view 102. Further, view 102 may output images to user. In an example, mobile device 100 may render a three dimensional environment and may display the three dimensional environment to the user in view 102 from the perspective of a virtual camera.

Mobile device 100 enables the user to navigate a virtual camera through a three dimensional environment. In an example, the three dimensional environment may include a three dimensional model, such as a three dimensional model of the Earth. A three dimensional model of the Earth may include satellite imagery texture mapped to three dimensional terrain. The three dimensional model of the Earth may also include, for example and without limitation, models of buildings and other points of interest.

In response to user input, mobile device 100 may change a perspective of the virtual camera. Based on the virtual camera's new perspective, mobile device 100 may render a new image into view 102. Various user interface gestures that change the virtual camera's perspective and result in a new image are described in detail below.

FIG. 2 shows a diagram 200 illustrating a virtual camera in a three dimensional environment. Diagram 200 includes a virtual camera 202. Virtual camera 202 is directed to view a three dimensional terrain 210. Three dimensional terrain 210 may be a portion of a larger three dimensional model, such as a three dimensional model of the Earth.

As mentioned earlier, user input may cause a mobile device, such as mobile device 100 in FIG. 1, to move virtual camera 202 to a new location. Further, user input may cause virtual camera 202 to change orientation, such as pitch, yaw, or roll. User input may also cause virtual camera 202 to zoom in closer to three dimensional terrain 210. User input may additionally cause virtual camera 202 to translate the view of the three dimensional terrain, by adjusting the angle at which a ray from the virtual camera intersects with the surface of the three dimensional terrain. User input may also cause the virtual camera 202 to pan along three dimensional terrain 210. User input may further cause virtual camera 202 to rotate the view of three dimensional terrain 210.

In this way, user interface gestures on a mobile device cause a virtual camera to navigate through a three dimensional environment on a mobile device. The various system components and details of the user interface gestures are described below.

### System

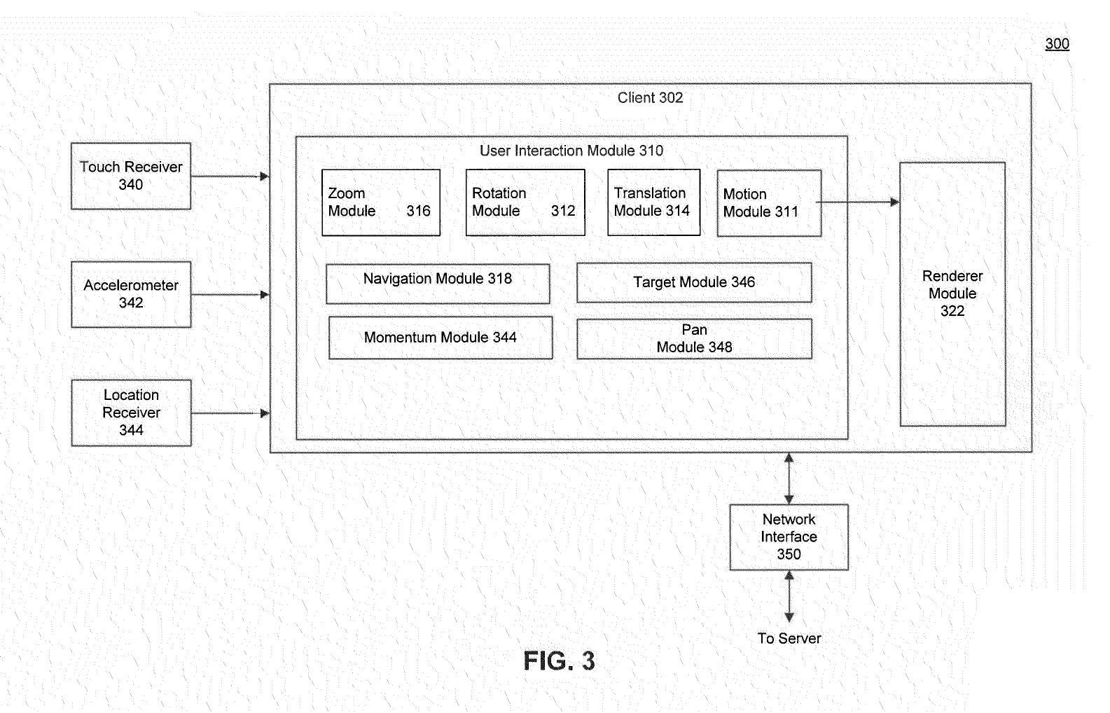

This section describes a system that navigates a virtual camera through a three dimensional environment on a mobile device in response to user interface gestures. FIG. 3 is a diagram illustrating a system 300 that accepts user interface gestures for navigation in a three dimensional environment on a mobile device.

System 300 includes a client 302 having a user interaction module 310 and a renderer module 322. User interaction module 310 includes a motion model 311. In general, client 302 operates as follows. User interaction module 310 receives user input regarding a location that a user desires to view and, through motion model 311, constructs a view specification defining the virtual camera. Renderer module 322 uses the view specification to decide what data is to be drawn and draws the data. If renderer module 322 needs to draw data that system 300 does not have, system 300 sends a request to a server for the additional data across one or more networks, such as the Internet, using a network interface 350.

Motion model 311 constructs a view specification. The view specification defines the virtual camera's viewable volume within a three dimensional space, known as a frustum, and the position and orientation of the frustum in the three dimensional environment. In an embodiment, the frustum is in the shape of a truncated pyramid. The frustum has minimum and maximum view distances that can change depending on the viewing circumstances. Thus, changing the view specification changes the geographic data culled to the virtual camera's viewable volume. The culled geographic data is drawn by renderer module 322.

The view specification may specify three main parameter sets for the virtual camera: the camera tripod, the camera lens, and the camera focus capability. The camera tripod parameter set specifies the following: the virtual camera position (X, Y, Z coordinates); which way the virtual camera is oriented relative to a default orientation, such as heading angle (e.g., north?, south?, in-between?); pitch (e.g., level?, down?, up?, in-between?); yaw and roll (e.g., level?, clockwise?, anti-clockwise?, in-between?). The lens parameter set specifies the following: horizontal field of view (e.g., telephoto?, normal human eye—about 55 degrees?, or wide-angle?); and vertical field of view (e.g., telephoto?, normal human eye—about 55 degrees?, or wide-angle?). The focus parameter set specifies the following: distance to the near-clip plane (e.g., how close to the “lens” can the virtual camera see, where objects closer are not drawn); and distance to the far-clip plane (e.g., how far from the lens can the virtual camera see, where objects further are not drawn). As used herein “moving the virtual camera” includes zooming the virtual camera, tilting the virtual camera, rotating the virtual camera, and panning the virtual camera.

To construct a view specification, user interaction module 310 receives user input. Client 302 has various mechanisms for receiving input. For example, client 302 may receive input using sensors including a touch receiver 340, an accelerometer 342, and a location module 344. Each of the sensors will now be described in turn.

Touch receiver 340 may be any type of touch receiver that accepts input from a touch screen. Touch receiver 340 may receive touch input on a view such as the view 102 in FIG. 1. The touch input received may include a position that the user touched as defined by an X and Y coordinate on the screen. The user may touch the screen with a finger, stylus, or other object. Touch receiver 340 may be able to receive multiple touches simultaneously if, for example, the user selects multiple locations on the screen. The screen may detect touches using any technology known in the art including, but not limited to, resistive, capacitive, infrared, surface acoustic wave, strain gauge, optical imaging, acoustic pulse recognition, frustrated total internal reflection, and diffused laser imaging technologies.

Accelerometer 342 may be any type of accelerometer as known to those skilled in the art. Accelerometer 342 may be able to detect when the mobile device moves. Accelerometer 342 also may be able to detect the orientation of a mobile device relative to gravity.

Location receiver 344 detects the location of the mobile device. Location receiver 344 may detect a location of a mobile device from, for example, a GPS receiver. A GPS receiver determines a location of the mobile device using signals from GPS satellites. In other examples, location receiver 344 may detect location of mobile device by, for example, collecting information from nearby cell towers and wi-fi hotspots. Location receiver 344 may use information from cell towers, wi-fi hotspots, and GPS satellites together to determine the location of the mobile device quickly and accurately.

As mentioned earlier, user interaction module 310 includes various modules that change the perspective of the virtual camera as defined by the view specification. User interaction module 310 includes a zoom module 316, a rotation module 312, a translation module 314, a navigation module 318, a pan module 348, and a target module 346. Each of these modules is described below.

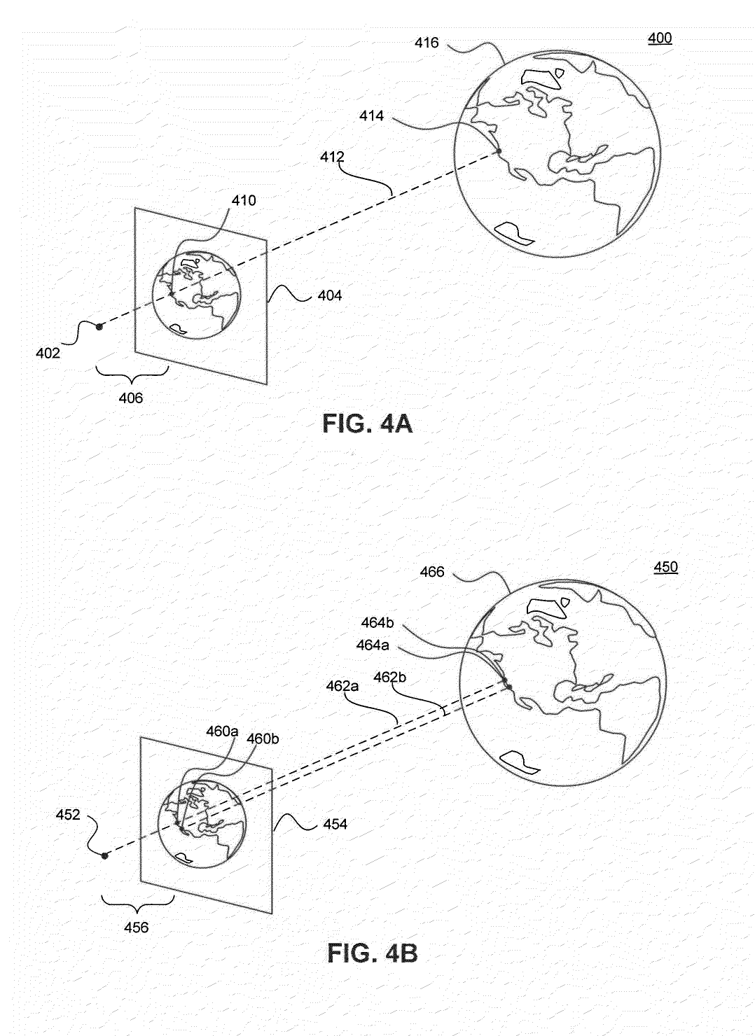

The modules in user interaction module 310 may change a virtual camera's perspective according to a target location. A target location may be determined by a target module 346. In an embodiment, target module 346 may extend a ray from a focal point of the virtual camera. The target location may be an intersection of the ray with a three dimensional model, such as a three dimensional model of the Earth. The ray may be extended according to a position on the view selected by a user. Alternatively, the ray may be extended through a center of the view frustum of the virtual camera. The operation of target module 346 is described in more detail with respect to FIGS. 4A-B.

One module that uses target module 346 is zoom module 316. Zoom module 316 zooms the virtual camera in response to a user interface gesture. In an embodiment, zoom module 316 is called when touch receiver 340 receives a two or more finger touch with the fingers performing a motion relative to each other. For example, the fingers may perform a pinch or expand gesture. That is, in a pinch gesture the two or more fingers may be dragged from their initial touch locations to be closer to one another, or the two or more fingers may be dragged across a touch receiver to be farther from one another. Zoom module 316 may determine a speed that the fingers moved relative to each other. Based on the position of the two or more fingers, target module 346 may determine two or more target locations. Zoom module 316 may further determine a speed of the virtual camera. Using the target location, zoom module 316 moves the camera at the determined speed. Moving the fingers towards each other may cause the virtual camera to move forward, whereas moving the fingers away or apart from each other may cause the virtual camera to move backwards. Zoom module 316 may simulate air resistance and consequently may reduce the speed of the virtual camera gradually. Zoom module 316 may move the virtual camera toward the target location in a smooth manner, and may decelerate the camera as it reaches the target zoom value. Moreover, zoom module 316 may move the virtual camera such that the positions of the two or more fingers remain consistent on the determined target locations. That is to say, if the target location of one finger corresponds to a particular object (such as a building) on the earth's surface, after the zooming is performed, that finger remains corresponding to that particular object.

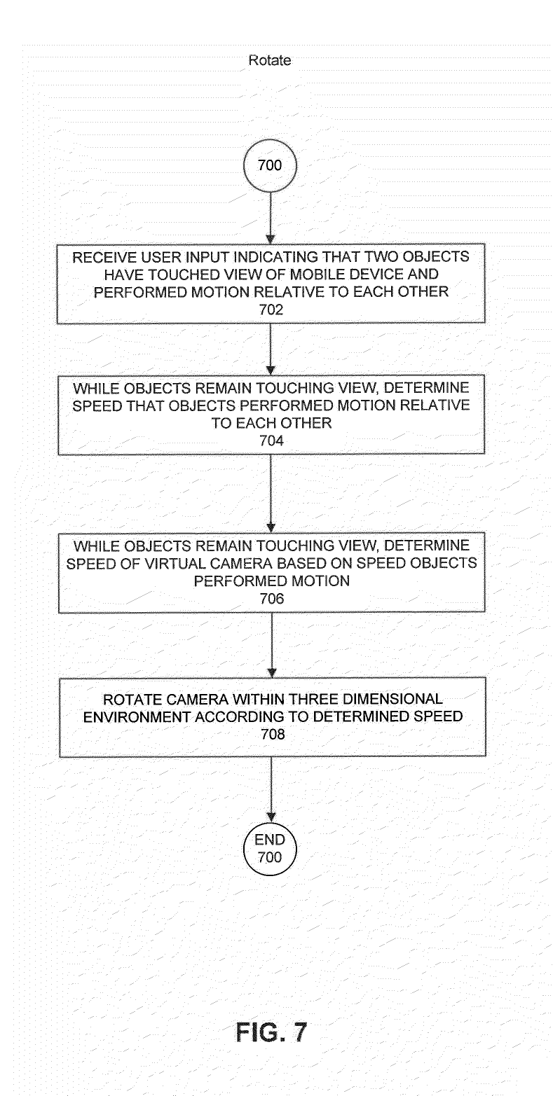

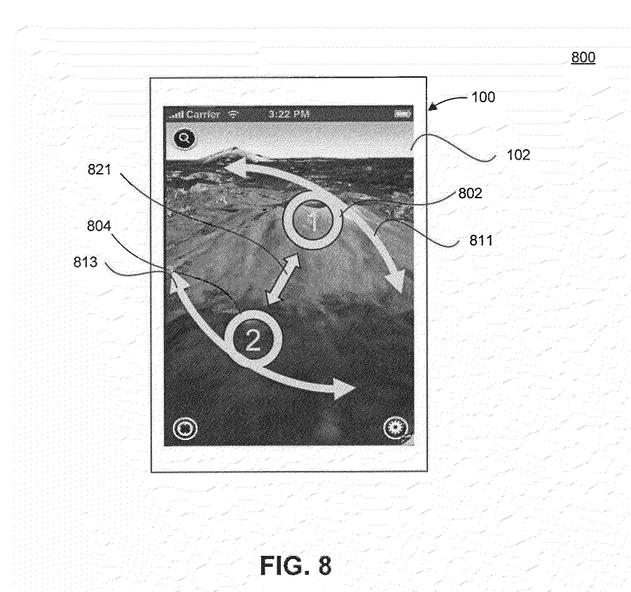

In one embodiment, the virtual camera may remain stationary and a three dimensional model, such as a three dimensional model of the Earth, may move according to the finger speed. Rotation module 312 may rotate a model of the Earth at an angular velocity determined according to a finger speed. Rotation module 312 moves the virtual camera in response to a user interface gesture. In an embodiment, rotation module 312 is called when touch receiver 340 receives a two or more finger touch with the fingers performing a motion relative to each other. For example, the fingers may rotate in an arc shape. Target module 346 determines two or more target locations based on the positions of the two or more fingers touching the view. Rotation module 312 changes an orientation of the virtual camera according to the movement of the two or more fingers. Touch receiver 340 may receive the direction of the two or more fingers' movement and send the direction to rotation module 312. Based on the direction, rotation module 312 may rotate the virtual camera along an axis. The operation of rotation module 312 is described in more detail with respect to FIG. 7 and FIG. 8. Rotation module 312 may operate in a manner similar to that of zoom module 316 as described above. Thus, the target locations corresponding to the positions of the two or more fingers remain consistent after the virtual camera is rotated along the axis.

In one embodiment, the virtual camera may be tilted in response to a user interface gesture. Tilting module 314 is called when touch receiver 340 receives a two or more finger touch with the fingers moving approximately the same distance, in approximately the same direction. For example, the fingers may be dragged across a view of a mobile device. Target module 346 determines two or more target locations based on the positions of the two or more fingers touching the view. Tilting module 314 changes an orientation of the virtual camera according to the movement of the two or more fingers. Touch receiver 340 may receive the direction of the fingers' movement and send the direction to tilting module 314. For example, tilting module 314 may change a tilt value of the virtual camera and zoom the virtual camera. Tilting module 314 may operate in a manner similar to that of zoom module 316 and rotation module 312 described above. Thus, target locations corresponding to the positions of the fingers remain consistent after the virtual camera is tilted.

In one embodiment, a three dimensional model, such as a three dimensional model of the Earth, may also be rotated by pan module 348. In an embodiment, touch receiver 340 may receive a user input indicating that a user has touched a first position on a view of the mobile device and moved one or more fingers to a second position on the view (a touch-and-drag gesture). Based on the first and second positions, target module 346 may determine first and second points in the three dimensional environment. Based on the first and second points, pan module 348 may move the three dimensional model relative to the virtual camera. This movement may be referred to herein as “panning.” In an example, pan module 348 may move the three dimensional model by determining a rotation axis on the three dimensional model and rotating the three dimensional model around the rotation axis.

Each of the components of system 300 may be implemented in hardware, software, firmware, or any combination thereof.

In the following sections, the operation of rotation module 312, translation module 314, zoom module 316, target module 346, momentum module 316, navigation module 318 and pan module 348 is described in greater detail.

Determining a target location is illustrated in FIG. 4. FIG. 4 shows a diagram 400 illustrating extending a screen ray to determine a target location. Diagram 400 shows a virtual camera with a focal point 402. The virtual camera has a focal length 406 and a viewport 404. On viewport 404, point 410 corresponds to a point selected by a user on a view of the mobile device. For example, point 410 may be a point determined based on a position of a user's fingers. From focal point 402, a ray 412 is extended through point 410. Ray 412 intersects with a three dimensional model 416 to determine a target location 414. In this way, target location 414 is determined based on the point selected by the user.

In accordance with one embodiment, a user may select two (or more) points on a view of the mobile device. FIG. 4B shows a diagram 450 illustrating extending a screen ray to determine two target locations. Diagram 450 shows a virtual camera with a focal point 452. The virtual camera has a focal length 456 and a viewport 454. On viewport 454, points 460a and 460b may be points determined based on positions of a user's fingers. Rays 462a and 462b extend from points 460a and 460b. Rays 462a and 462b intersect with a three dimensional model 466 to determine target locations 464a and 464b. In this way, target locations 464a and 464b are determined based on the points selected by the user.

While being easy for user, selecting a point on a mobile device may be imprecise. Mobile devices tend to have small views (handheld mobile devices, for example, may have views generally not larger than 4.5 inches). As result, a finger touch may occupy a substantial portion of the view. When the user selects a position that is close to the horizon, the screen ray may be nearly tangential to the three dimensional model. Small changes in the position of the wide finger may result in large changes in the target location. As a result, navigation may be unstable. For that reason, virtual surfaces may be used to damp the user's selections.

Referring back to FIG. 3, navigation module 318 orients and positions the virtual camera in the three dimensional environment according to orientation and position information received from accelerometer 342 and location receiver 344. Location receiver 344 may receive a heading value of the mobile device. For example, location receiver 344 may receive the cardinal direction (north, east, south, west) that the mobile device faces. Based on the heading value, navigation module 318 may orient the virtual camera in the direction of the mobile device. Also, location receiver 344 may receive a location value of the mobile device. For example, location receiver 344 may receive may receive a latitude, longitude and altitude of the mobile device. Based on the location of the mobile device, navigation module 318 may position a virtual camera in the three dimensional environment. The three dimensional environment may include a three dimensional model of the Earth. In this way, navigation module 318 may position and orient the virtual camera in the virtual Earth to correspond to the position and orientation of the mobile device in the real Earth. Navigation module 318 may continually update the position and orientation of the virtual camera to track the mobile device.

Each of rotation module 312, translation module 314, zoom module 316, and pan module 348 accept user interface gestures to move the virtual camera. Each of those modules may coordinate with momentum module 344 to continue the motion of the virtual camera after the user interface is gesture is complete. Momentum module 344 may gradually decelerate the motion after the gesture is complete. In this way, momentum module 344 simulates the virtual camera having a momentum and simulates the virtual camera being subjected to friction, such as air resistance.

### Pinch Zoom

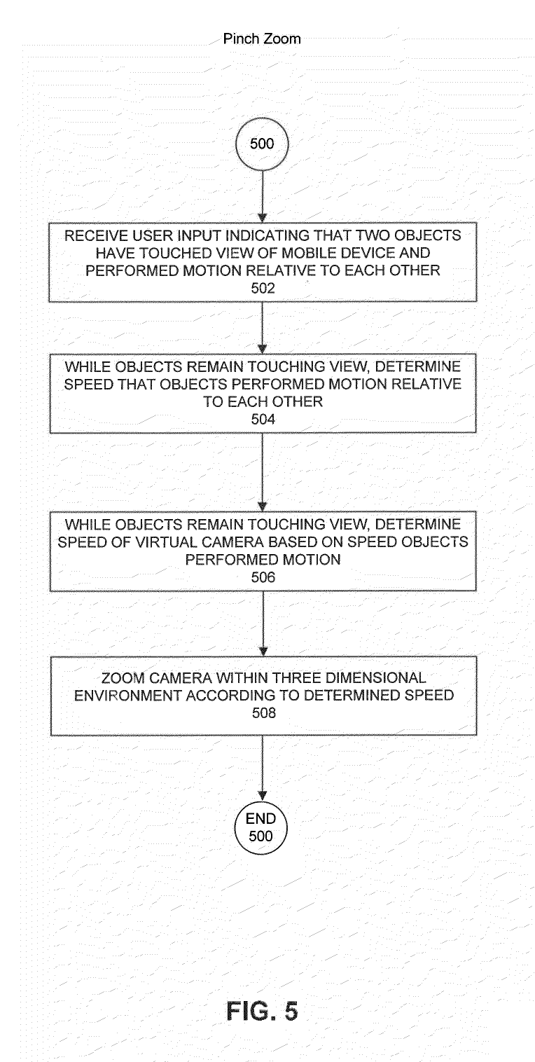

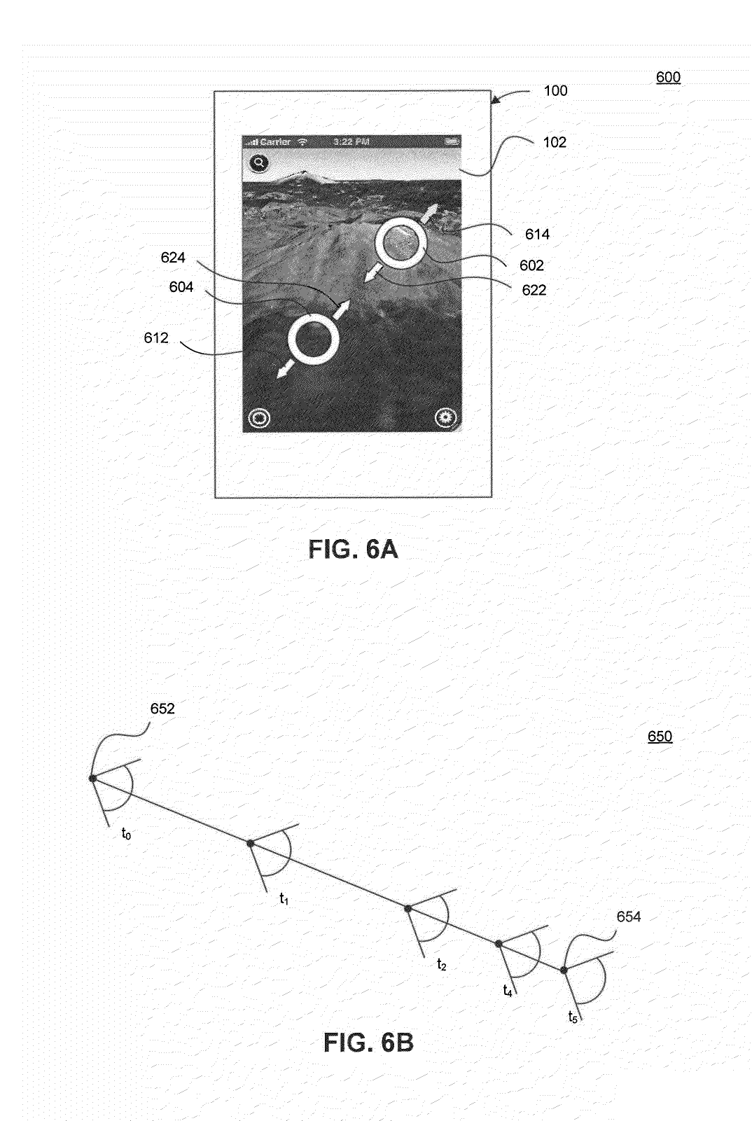

This section describes a two finger gesture with both fingers initially in motion. The two finger gesture may be referred to as a pinch and is described with respect to FIG. 5 and FIGS. 6A-6B.

FIG. 5 is a flowchart illustrating a method 600 for navigating a virtual camera using a pinch. Method 500 begins at step 502 by receiving a user input indicating that two or more objects, such as fingers, have touched a view of a mobile device and performed a motion relative to each other. In one embodiment, the movement may represent a user pinch on the view at step 502. A user pinch is described below, and illustrated in FIG. 6A.

FIG. 6A shows a diagram 600 illustrating a pinch gesture on a mobile device. Diagram 600 shows mobile device 100 with view 102. A user has touched view 102 with fingers 604 and 602. Both fingers are in motion and their relative motion is a speed of the pinch determined in step 504, while both fingers remain touching the view. Moving fingers 604 and 602 apart as shown with arrows 612 and 614 may result in a positive pinch speed, whereas moving fingers 604 and 602 together as shown with arrows 624 and 622 may result in a negative pinch speed.

Based on the pinch speed determined in step 504, a virtual camera speed is determined at step 506 while the fingers remain touching the view. The virtual camera speed may be positive (forward) if the pinch speed is positive, and the virtual camera speed may be negative (reverse) if the pinch speed is negative. In an example, the virtual camera speed may be linearly interpolated from the pinch speed. Linear interpolation is an illustrative example and this not meant to limit the embodiments disclosed herein.

At step 508, the virtual camera zooms within the three dimensional environment according to the speed determined at step 506. The virtual camera may zoom by accelerating to the speed determined at step 506 and then may decelerate gradually. To decelerate the virtual camera, a momentum of the virtual camera may be simulated, and the virtual camera may be exposed to a simulated air resistance. Acceleration and deceleration are illustrated in FIG. 6B.

FIG. 6B shows a diagram 650 illustrating a virtual camera subjected to a pinch momentum. Diagram 650 shows a virtual camera starting at a position 652 and ending at a position 654 along virtual line 656. Diagram 650 shows the virtual camera at several points in time t₀, t₁, t₂, t₃, t₄, and t₅. As time passes, the virtual camera decelerates.

In another embodiment, both fingers need not be initially in motion. One or both fingers could be initially stationary. Further, a pinch may translate the virtual camera or cause a virtual camera to zoom without any momentum. In that embodiment, the virtual camera zooms or translates according a distance or speed of the pinch. When the pinch gesture is completed, the virtual camera may stop zooming or translating.

In an embodiment, the virtual camera is zoomed towards the center of the currently displayed view. In a further embodiment, the virtual camera is zoomed towards the center of the two objects placed on the view. For example, target module 346 may determine the center point of the two objects placed on the view, and the virtual camera may be zoomed towards this point.

### Rotation

This section describes a further two finger gesture with both fingers initially in motion. The two finger gesture may be referred to as a rotation, and is described with respect to FIG. 7 and FIG. 8. In one embodiment, the gesture may be performed with more than two fingers.

FIG. 7 is a flowchart illustrating a method 700 for navigating a virtual camera using a rotation. Method 700 begins at step 702 by receiving a user input indicating that two objects, such as fingers, have touched a view of a mobile device, or remained touching a view of a mobile device, and performed a motion relative to each other. In one embodiment, the movement may represent a user rotation on the view at step 702. A user rotation is described below, and illustrated in FIG. 8.

FIG. 8 shows a diagram 800 illustrating a rotation gesture on a mobile device. Diagram 800 shows mobile device 100 with view 102. A user has touched view 102 with finger 1 802 and finger 2 804. Both fingers then may make a motion relative to each other as illustrated by arrows 811 and 813. For example, both fingers may rotate in an arc about a virtual center point. While both fingers remain touching the view, a speed that the objects performed the motion relative to each other is determined in step 704. The direction that the objects performed the motion may also be determined in step 704. For example, finger 802 may be determined to be moving towards the bottom of the view, while finger 804 may be determined to be moving towards the top of the view. The motion of the fingers may be aggregated into a vector.

Based on the speed determined in step 704, a virtual camera speed is determined at step 706 while the fingers remain touching the view. The speed of the virtual camera may also indicate the direction of the rotation, based on the direction of the rotation determined at step 704.

At step 708, the virtual camera rotates within the three dimensional environment according to the virtual camera speed determined at step 706. The virtual camera may rotate by accelerating to the speed determined at step 706 and then may decelerate gradually. The virtual camera may rotate according to the direction of the fingers, and may appear to rotate about an axis centered by the midpoint of the fingers.

Rotating finger 1 and finger 2 as illustrated by arrows 811 and 813 may result in rotating the camera around a target point. The target point may be determined by extending a screen ray as described for FIGS. 4A-B. In examples, the screen ray may be determined based on a midpoint between the fingers. In this way, the target point is not covered by one of the user's fingers on the display.

Once the target point is determined, the camera may rotate around the target point. In one embodiment, the camera may rotate around the target point by changing an azimuth value. In this way, the camera may helicopter around a target point, viewing the target from different perspectives.

In one embodiment, an “invisible” line may be determined connecting finger 1 and finger 2. When a user rotates finger 1 and 2 as illustrated by arrows 811 and 813, an angle between the invisible line and the display of the mobile device changes as well. When the angle between the invisible line and the display of the mobile device changes, an azimuth angle relative to a target point may also change. In one embodiment, the azimuth angle may change by the same amount, or approximately the same amount, as the angle between the invisible line and the display of the mobile device. In this way, when a user rotates two fingers on the display of the mobile device by 360 degrees, the virtual camera helicopters 360 degrees around the target point.

In one embodiment, the virtual camera may stay stationary and the three dimensional model may move. In an example, the three dimensional model may rotate. This motion of the three dimensional model relative to the virtual camera may be referred to as “panning”, and is further described below.

### Zoom and Rotate

In one embodiment, the virtual camera is both zoomed and rotated. The rotation of the camera is based on the angle between the two or more fingers, and the zoom is based on the distance between the two or more fingers. These two actions can be done immediately following one another, without lifting the fingers from the surface. The zoom may be followed by the rotation, or the rotation may be followed by a zoom. This embodiment is also illustrated in FIG. 8.

In FIG. 8, finger 1 802 and finger 2 804 are in contact with surface at the same time. Further, finger 1 802 and finger 2 804 may be in motion at the same time.

Changing a distance between finger 1 and finger 2, as illustrated with arrow 821, may change a range of virtual camera, e.g., by zooming or translating the virtual camera, as described above. In one example, an invisible line connecting finger 1 and 2 is determined as described above. When the invisible line increases in length, the camera may move away from a target point. Similarly, when the invisible line decreases in length, the camera may move toward a target point, or vice versa. Changing the range is described above with respect to FIGS. 5A-5B. Further, a momentum may be applied to continue the gesture as discussed above. A speed of either the rotation, the zoom, or both may diminish gradually after removal of fingers based on a speed at end of gesture.

In one example operation, the user may move finger 1 and 2 apart, and subsequently rotate finger 1 and 2 counter-clockwise by 90 degrees. In such an operation, the virtual camera may zoom closer to the target point, and rotate around the target point by 90 degrees counter-clockwise and may zoom closer to the target point. In another example operation, the user may rotate finger 1 and 2 clockwise by 45 degrees and may move finger 1 and 2 closer together. In that example, the virtual camera may helicopter around the target point by 45 degrees clockwise and may zoom away from the target point.

By zooming and rotating in a single user interface gesture, embodiments enable a user to navigate easily around a target point and to view a target from different perspectives.

### Tilting the Virtual Camera

This section describes a gesture that may cause a virtual camera to tilt its view. The gesture described in this section includes two fingers touching the display. In general, two fingers move in approximately the same direction by approximately the same distance and the virtual camera moves according to the finger movement. In one embodiment, the gesture may include more than two fingers touching the display.

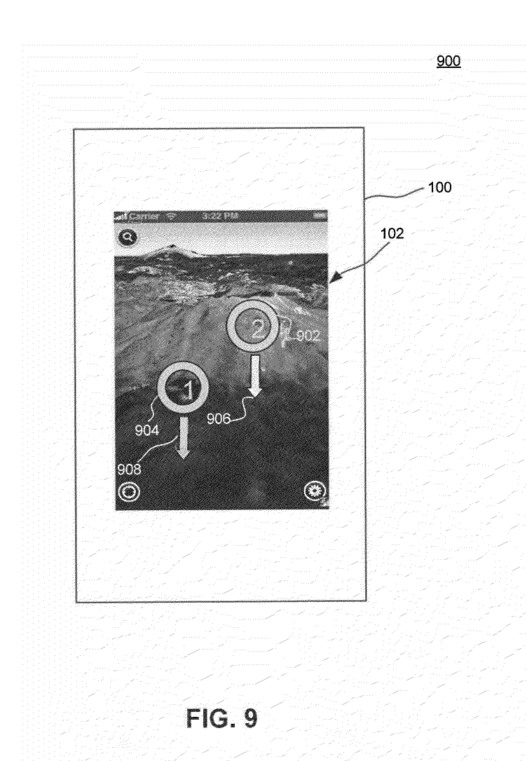

FIG. 9 shows a diagram 900 illustrating a two finger gesture for tilting a virtual camera in a three dimensional environment on a mobile device. Diagram 900 shows mobile device 100 with view 102. Touching view 102 are fingers 902 and 904. With the user touching view 102, the user moves fingers 902 and 904 on view 102 as shown by vectors 906 and 908. Vectors 906 and 908 represent the direction and distance that a user moves fingers 902 and 904.

Vectors 906 and 908 may be in approximately in the same direction. Vectors 906 and 908 need not be exactly parallel. A small angle between vectors 906 and 908 may be allowed up to a threshold. Similarly, vectors 906 and 908 may have approximately the same length. A small difference in the length of vectors 906 and 908 may be allowed up to a threshold.

Based on the direction and distance that the user moves fingers 902 and 904, a virtual camera's orientation changes. If fingers 902 and 904 have moved slightly different directions and distances then the direction and distance values may be combined to determine an aggregate vector. In an example, the direction and distance values of vectors 906 and 908 may be averaged to determine the aggregate vector. Here a vector is described but any type of motion data may be used.

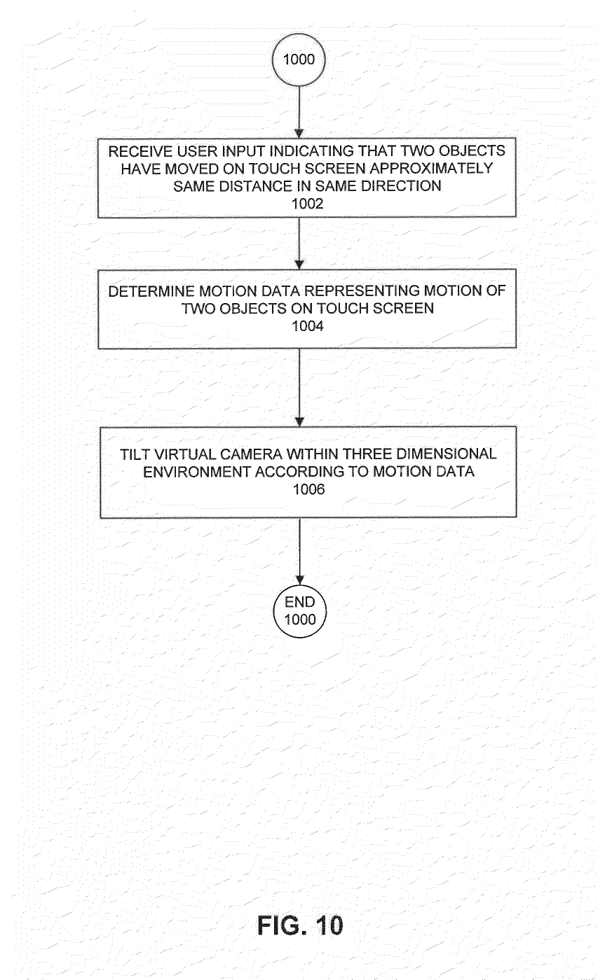

FIG. 10 is a flowchart illustrating a method 1000 for tilting a virtual camera on a mobile device. Method 1000 begins at step 1002 with receiving a user input indicating that two objects have moved on a view of a mobile device approximately the same distance in approximately the same direction. For example, the two objects may be a user's fingers which move as described above with reference to FIG. 9.

In response to the user input received at step 1002, motion data representing the motion of the two objects on the touch screen is determined at step 1004. For example, the motion data may represent that the two objects moved a particular distance towards the bottom of the view of the mobile device, or towards the top of the view of the mobile device. The motion data may be represented as a vector.

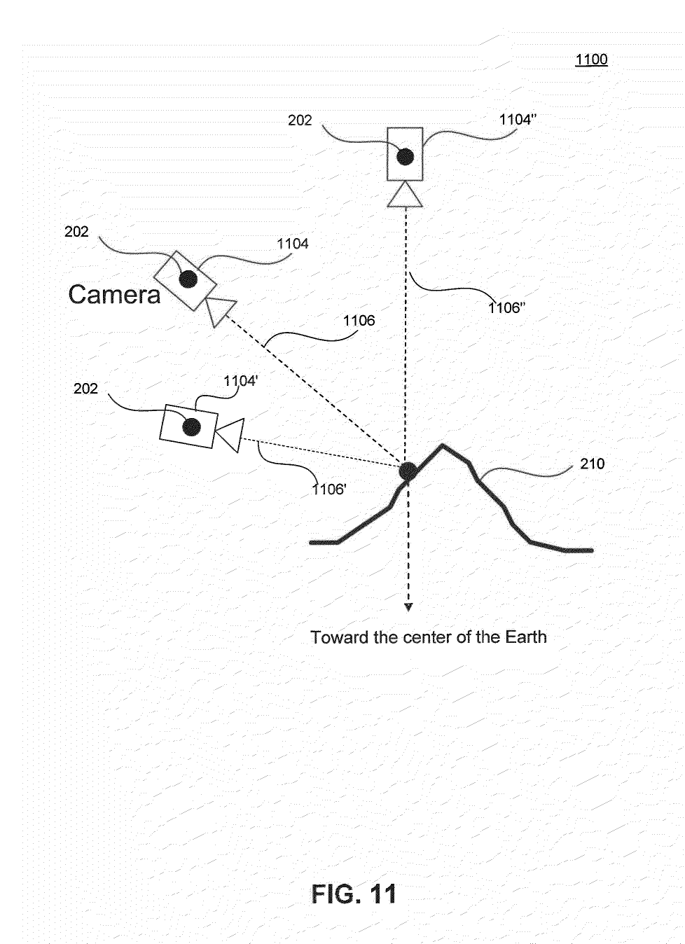

At step 1006, the virtual camera is translated within the three dimensional environment, according to the motion data. An example of translating a virtual camera within the three dimensional environment is shown in FIG. 11.

FIG. 11 shows a diagram 1100 with three dimensional terrain 210 and virtual camera 202. Virtual camera 202 may initially be approximately tangent to the surface of the three dimensional terrain 210. In response to a user input in accordance with step 1102, a user's fingers 1002 and 1004 may move approximately the same distance in the same direction on a view of a mobile device.

In response to movement of fingers 902 and 904, the virtual camera may change its orientation as illustrated in FIG. 11. FIG. 11 shows a diagram 1100 with three dimensional terrain 210 and virtual camera at position 202. Virtual camera 202 at position 1104 is at a particular distance from the surface of three dimensional terrain 210, as depicted by line 1106. When the vector of finger movement is towards the bottom of the mobile device, the virtual camera may move in substantially an arc shape relative to three dimensional terrain 210 to where virtual camera 202 is depicted at position 1104′. Further, the pitch of virtual camera 202 may change. Changing the virtual camera's pitch may cause the camera to tilt upwards. Additionally, as shown in FIG. 11, the virtual camera 202 may be slightly zoomed in towards the surface of three dimensional terrain 210. This may be seen as line 1106′ is shorter than line 1106.

When the vector of finger movement is towards the top of the mobile device, the virtual camera's pitch may also change. In this case, changing the virtual camera's pitch may cause the camera to tilt downwards. Thus, as illustrated in FIG. 11, virtual camera 202 may move towards position 1104″. At position 1104″, virtual camera 202 may be at a greater distance from the three dimensional terrain 210, as depicted by line 1106″.

As seen in FIG. 11, tilting the virtual camera may cause it to move in substantially an arc shape. As the virtual camera approaches the surface of the three dimensional model, it may zoom in closer to the surface of the three dimensional model. That is to say, the greater the distance from 90 degrees the angle tangent to the center of the earth is, the closer the virtual camera will be to the ground.

### Panning

The previous sections describe gestures for zooming, rotating, and translating a virtual camera. Zooming, rotating, and translating the camera may be performed using gestures with two or more fingers. This section describes panning a virtual camera through a three dimensional environment on a mobile device. In general, a user pans by selecting a position on the view of the mobile device with one or more fingers. Based on the selected position, one or more target locations are determined. As the user drags his finger(s), the position of the three dimensional model relative to the virtual camera moves to follow the target location. This may be referred to as a touch-and-drag gesture. In an embodiment, the virtual camera moves in a straight line to another portion of the virtual model. The virtual camera may maintain the same angle tangent to the surface of the virtual model and the same altitude.

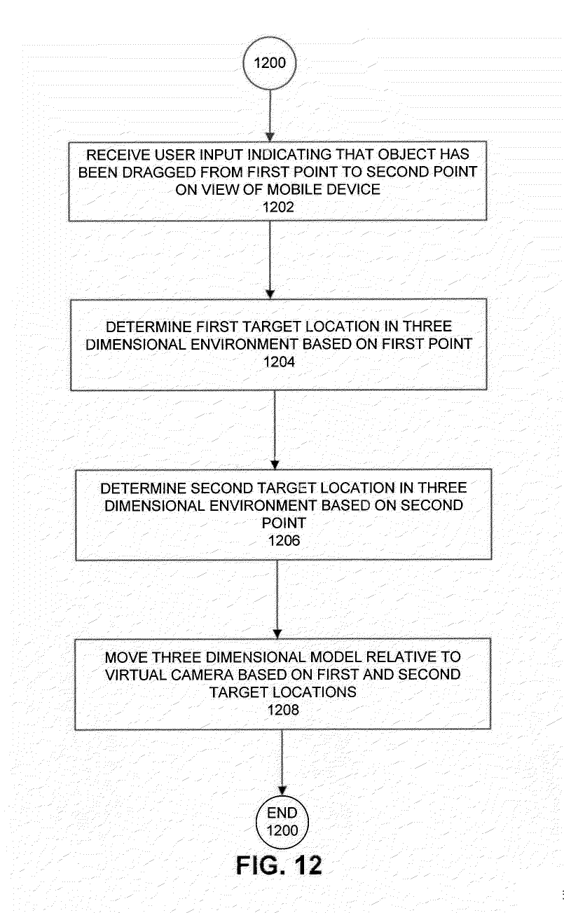

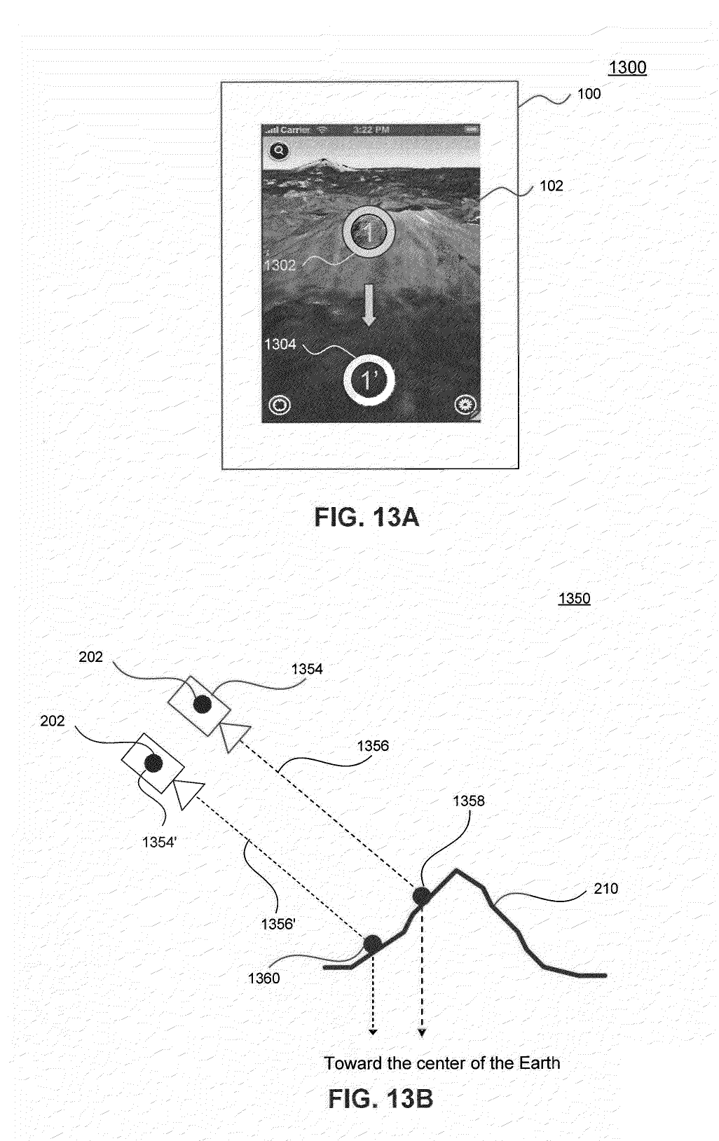

FIG. 12 is a flowchart illustrating a method 1200 for panning on a mobile device in accordance with an embodiment. Method 1200 begins at step 1202, where a user input indicating that an object or finger has been dragged from a first point to a second point on the view of the mobile device is received. Receiving the first and second positions is illustrated in FIG. 13A. Each of the first and second position may be defined by an X and Y coordinate on the view. FIG. 13A shows a diagram 1300 illustrating panning on a mobile device. Diagram 1300 shows mobile device 100 with view 102. A user touches a position 1302 with his finger and drags his finger to a new position 1304.

Based on position 1302, a first target location is determined at step 1204. Further, based on position 1304, a second target location is determined at step 1206.

Based on the first and second target locations, the three dimensional model may be moved relative to the virtual camera in step 1210. In one embodiment, the altitude of the virtual camera with respect to the three dimensional model may stay constant. Further, the angle at which a ray extending from the virtual camera to the surface of the three dimensional model intersects the surface of the three dimensional model may stay constant.

The first and second target locations may be determined with rays as described with respect to FIG. 4A-B. If the ray is nearly tangential to the three dimensional model, the target point may need to be damped. Each target point may be defined by, for example, a latitude, longitude, and altitude. Altitude (as the term is meant here) may be the distance from the target point to a center of the three dimensional model. In an embodiment, the first target point is determined by intersecting a ray with the three dimensional model. Determining the target points is illustrated in FIG. 13B.

FIG. 13B shows a diagram 1350 with virtual camera 202 facing three dimensional terrain 210. As mentioned earlier, three dimensional terrain 210 may be a portion of a three dimensional model. Virtual camera 202 at position 1354 is at a particular distance from the surface of three dimensional terrain 210, as depicted by line 1306. The first target location determined may correspond to point 1358 on the surface of the terrain 210.

When the a user input indicating that an object or finger has been dragged from point 1358 in accordance with step 1204, the virtual camera may pan along three dimensional terrain 210. The second target location may be determined to be, for example, point 1360. Thus, the virtual model of the earth may move such that virtual camera 202 appears to pan to position 1354′. As explained above, in panning mode, the virtual camera's pitch and altitude may stay constant. Thus, line 1306′ may be substantially the same length as line 1306, and the three dimensional model may be moved such that virtual camera 202 views the second target location 1360.

In this way, after zooming or rotating the virtual camera as described above, the user may pan the virtual camera to view other areas of the virtual surface.

Navigation with a Single Gesture

The above sections have described gestures for zooming the virtual camera, rotating the virtual camera, translating the virtual camera, and panning the virtual camera. In this section, embodiments are described which may allow a user to navigate the environment in one gesture, without lifting his or her fingers or other objects from the view of the mobile device.

FIG. 14 is a flowchart illustrating a method 1400 for navigating on a mobile device. Method 1400 begins at step 1402, where a user input indicating that two or more objects have touched a view of the mobile device is received.

Based on the user input, at step 1404, the target locations on the Earth's surface corresponding to the position of the two or more objects on the view of the mobile device are determined. In one embodiment, the target locations are determined as described in FIGS. 4A-4B.

At step 1406, a user input indicating that the two or more objects have performed a motion while touching the view of the mobile device is received. In accordance with one embodiment, the motion may include performing a pinch motion, as illustrated in FIG. 6A, performing a rotate motion, as illustrated in FIG. 8, or performing a tilting motion, as illustrated in FIG. 9. The motion may include any combination of the pinch, rotate, and tilting motions.

At step 1408, based on the detected motion of the two objects, updated camera parameters are determined such that the target locations on the Earth's surface determined at step 1404 remain constant. Thus, for example, if the motion performed by the user includes spreading the two objects apart while moving the two objects towards the bottom of the view of the mobile device, the camera may be zoomed and tilted, as described herein.

At step 1410, based on the determined camera parameters, the virtual camera is moved within the three dimensional environment. Moving the virtual camera may include at least two of zooming, rotating, tilting, or panning the virtual camera. The virtual camera is moved such that the target locations of the two objects touching the screen remain constant. The virtual camera may be moved at a speed that corresponds to the speed the two objects performed the motion on the mobile device.

Although FIG. 14 has been described with reference to two objects touching a view of the mobile device, in one embodiment, more than two objects may be touching the mobile device. For example, a user may use three objects or fingers to touch the mobile device, and perform gestures on the mobile device. In accordance with one embodiment, target locations of the three objects are determined as described with reference to FIGS. 4A and 4B. Further, based on the detected motion of the three objects, camera parameters are determined such that the target locations on the Earth's surface remain constant. The virtual camera may then be zoomed, rotated, or tilted in accordance with the determined camera parameters.

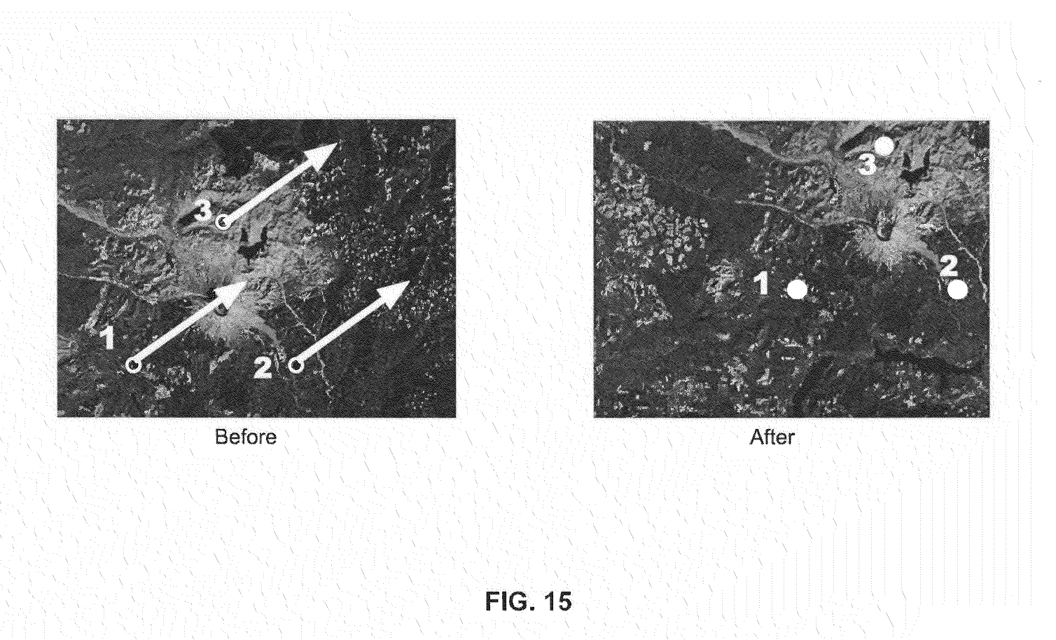

FIGS. 15-18 illustrate examples of moving a virtual camera according to camera parameters after two or more objects have touched a view of a mobile device and subsequently performed a motion. FIG. 15 displays three objects touching a view of a mobile device, and performing a motion as indicated by the arrows of FIG. 15. In accordance with an embodiment, target locations corresponding to the objects touching the view are determined. Based on the detected motion of the objects, camera parameters are determined such that the target locations corresponding to the objects touching the view are constant. Thus, in the example of FIG. 15, the virtual model of the Earth moves such that the virtual camera appears to pan, as described herein.

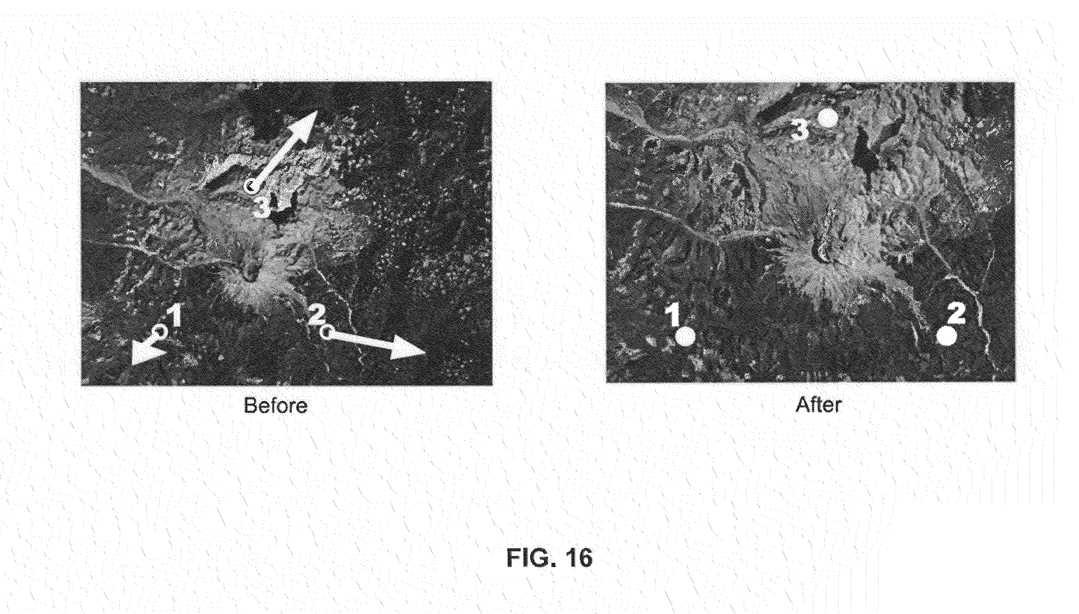

FIG. 16 also displays three objects touching a view of a mobile device, and performing a motion as indicated by the arrows of FIG. 16. In FIG. 16, the three objects have spread apart, and two of the objects have moved towards the right of the view of the mobile device. In accordance with an embodiment, target locations corresponding to the objects touching the view are determined, and based on the detected motion of the objects, camera parameters are determined such that the target locations corresponding to the objects are constant. Accordingly, in the example of FIG. 16, the virtual camera is zoomed (because the objects have spread apart) and also translated (because two of the objects moved in similar directions).

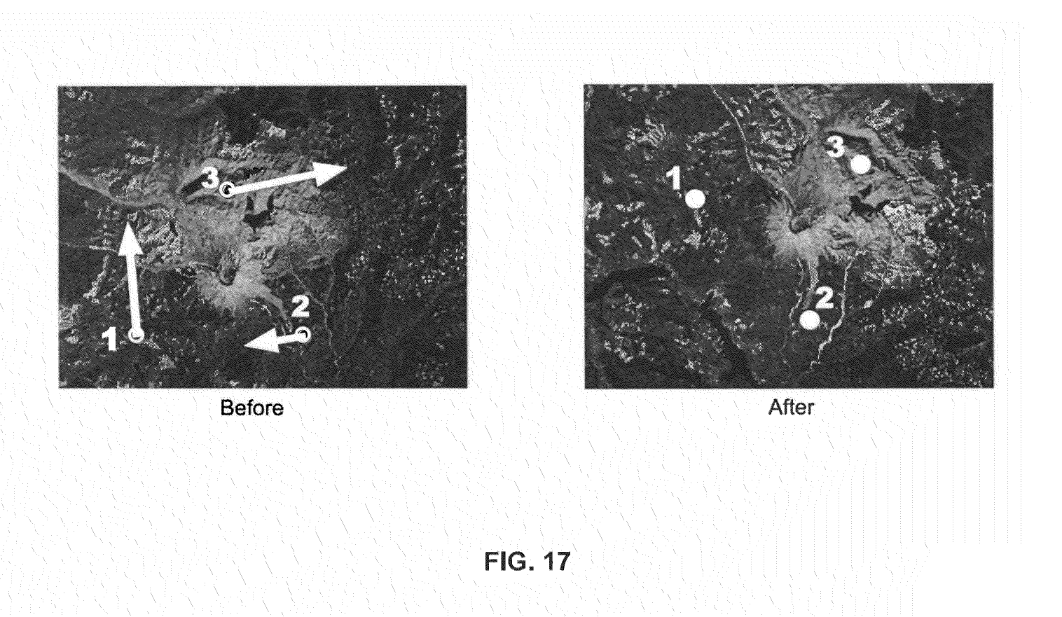

FIG. 17 displays three objects touching a view of a mobile device, and performing a motion as indicated by the arrows of FIG. 17. In FIG. 17, the three objects have rotated about the center of the three objects, and two of the objects have moved across the view of the mobile device a greater distance than one of the objects. In accordance with an embodiment, target locations corresponding to the objects touching the view are determined, and based on the detected motion of the objects, camera parameters are determined such that the target locations corresponding to the objects are constant. Accordingly, in the example of FIG. 17, the virtual camera is rotated (because the objects have rotated) and also panned (because two of the objects moved a greater distance than one of the objects).

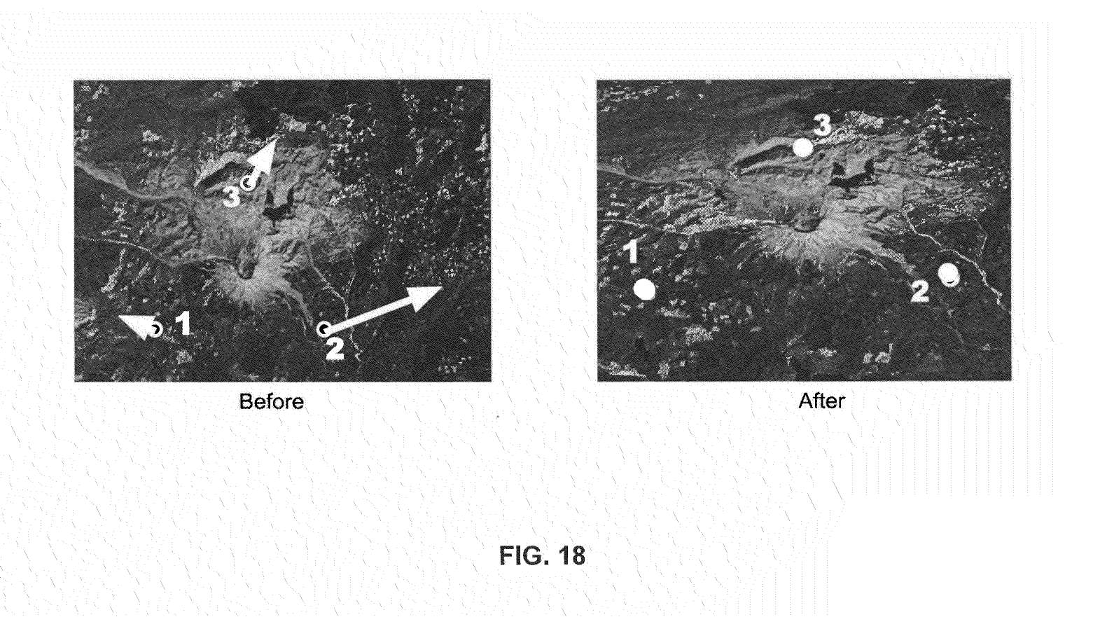

FIG. 18 displays three objects touching a view of a mobile device, and performing a motion as indicated by the arrows of FIG. 17. In FIG. 17, the three objects have spread apart, and two of the objects have moved across the view in substantially the same direction. In accordance with an embodiment, target locations corresponding to the objects touching the view are determined, and based on the detected motion of the objects, camera parameters are determined such that the target locations corresponding to the objects are constant. Accordingly, in the example of FIG. 18, the virtual camera is tilted (because two of the objects moved in the same direction) and also zoomed (because the objects spread apart).

Embodiments may be directed to computer products comprising software stored on any computer usable medium. Such software, when executed in one or more data processing device, causes a data processing device(s) to operate as described herein.

Embodiments may be implemented in hardware, software, firmware, or a combination thereof. Embodiments may be implemented via a set of programs running in parallel on multiple machines.

The summary and abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A computer-implemented method for navigating a virtual camera in a three-dimensional environment on a mobile device having a touch screen, comprising:
(a) receiving a first user input indicating that two or more objects have touched a view of the mobile device;
(b) determining two or more target locations on a surface of the three-dimensional environment corresponding to the two or more objects touching the view of the mobile device;
(c) receiving a second user input indicating that the two objects have performed a motion while touching the view of the mobile device;
(d) determining updated camera parameters for the virtual camera, based on the received second user input, such that the two or more target locations determined in (b) remain corresponding to the two or more objects touching the view of the mobile device; and
(e) moving the virtual camera within the three dimensional environment according to the updated camera parameters, wherein moving the virtual camera comprises at least two of zooming, rotating, tilting, and panning the virtual camera.

2. The method of claim 1, wherein zooming the virtual camera further comprises changing a position of the virtual camera along a virtual line.

3. The method of claim 1, wherein rotating the virtual camera further comprises changing an azimuth value of the virtual camera.

4. The method of claim 1, wherein tilting the virtual camera comprises changing an angle of the virtual camera relative to a normal that intersects with the surface of three-dimensional environment, and changing a position of the virtual camera along a virtual line.

5. The method of claim 1, wherein panning the virtual camera comprises rotating the three-dimensional environment in the view of the virtual camera.

6. The method of claim 1, further comprising:
determining a speed that the two or more objects performed the motion while touching the view of the mobile device, and
wherein (e) moving the virtual camera within the three dimensional environment further comprises moving the virtual camera according to the determined speed.

7. The method of claim 1, wherein the surface of the three-dimensional environment represents the surface of a three-dimensional model of the Earth.

8. The method of claim 1, wherein (b) determining two or more target locations on a surface of the three-dimensional environment corresponding to the two or more objects touching the view of the mobile device further comprises extending a ray from two or more points corresponding to the two or more objects touching the view of the mobile device, wherein the ray intersects with the surface of the three-dimensional environment.

9. A system for navigating a virtual camera in a three dimensional environment on a mobile device, comprising:
a touch receiver that:
receives a first user input indicating that two or more objects have touched a view of the mobile device, and
receives a second user input indicating that the two or more objects have performed a motion while touching the view of the mobile device;
a target module that determines two or more target locations on a surface of the three-dimensional environment corresponding to the two or more objects touching the view of the mobile device; and
a navigation module that determines updated camera parameters for the virtual camera, based on the received second user input, such that the two or more determined target locations remain corresponding to the two or more objects touching the view of the mobile device, and that moves the virtual camera within the three dimensional environment according to the updated camera parameters, such that the two or more target locations remain corresponding to the two or more objects touching the view of the mobile device, wherein moving the virtual camera comprises at least two of zooming, rotating, tilting, and panning the virtual camera.

10. The system of claim 9, wherein zooming the virtual camera further comprises changing a position of the virtual camera along a virtual line.

11. The system of claim 9, wherein rotating the virtual camera further comprises changing an azimuth value of the virtual camera.

12. The system of claim 9, wherein tilting the virtual camera comprises changing an angle of the virtual camera relative to a normal that intersects with the surface of three-dimensional environment, and changing a position of the virtual camera along a virtual line.

13. The system of claim 9, wherein panning the virtual camera comprises rotating the three-dimensional environment in the view of the virtual camera.

14. The system of claim 9, wherein the touch receiver is further configured to determine a speed that the two or more objects performed the motion while touching the view of the mobile device, and wherein the navigation module is further configured to move the virtual camera according to the determined speed.

15. The system of claim 9, wherein the surface of the three-dimensional environment represents the surface of a three-dimensional model of the Earth.

16. The system of claim 9, wherein the target module is further configured to determine two or more target locations on a surface of the three-dimensional environment by extending a ray from two or more points corresponding to the two or more objects touching the view of the mobile device

17. A computer readable storage medium having instructions stored thereon that, when executed by a processor, cause the processor to perform operations including:
(a) receiving a first user input indicating that two or more objects have touched a view of the mobile device;
(b) determining two or more target locations on a surface of the three-dimensional environment corresponding to the two or more objects touching the view of the mobile device;
(c) receiving a second user input indicating that the two objects have performed a motion while touching the view of the mobile device;
(d) determining updated camera parameters for the virtual camera, based on the received second user input, such that the two or more target locations determined in (b) remain corresponding to the two or more objects touching the view of the mobile device; and
(e) moving the virtual camera within the three dimensional environment according to the updated camera parameters, wherein moving the virtual camera comprises at least two of zooming, rotating, tilting, and panning the virtual camera.

18. The computer readable storage medium of claim 17, wherein zooming the virtual camera further comprises changing a position of the virtual camera along a virtual line.

19. The computer readable storage medium of claim 17, wherein rotating the virtual camera further comprises changing an azimuth value of the virtual camera.

20. The computer readable storage medium of claim 17, wherein tilting the virtual camera comprises changing an angle of the virtual camera relative to a normal that intersects with the surface of three-dimensional environment, and changing a position of the virtual camera along a virtual line.

21. The computer readable storage medium of claim 17, wherein panning the virtual camera comprises rotating the three-dimensional environment in the view of the virtual camera.

22. The computer readable storage medium of claim 17, further comprising:
determining a speed that the two or more objects performed the motion while touching the view of the mobile device, and
wherein (e) moving the virtual camera within the three dimensional environment further comprises moving the virtual camera according to the determined speed.

23. The computer readable storage medium of claim 17, wherein the surface of the three-dimensional environment represents the surface of a three-dimensional model of the Earth.

24. The computer readable storage medium of claim 17, wherein (b) determining two or more target locations on a surface of the three-dimensional environment corresponding to the two or more objects touching the view of the mobile device further comprises extending a ray from two or more points corresponding to the two or more objects touching the view of the mobile device, wherein the ray intersects with the surface of the three-dimensional environment.
